(19) United States
(12) Patent Application Publication
(10) Pub. No.: US 2016/0005059 A1
(43) Pub. Date: Jan. 7, 2016

(54) COMPARABLE MARKET-SEGMENT VALUATION SYSTEM

(71) Applicant: Bank of America Corporation, Charlotte, NC (US)

(72) Inventors: Amul Shah, Gurgaon (IN); Chaitrali Khandeparkar Banerjee, Manikonda (IN); Ashis Kanvinde, Goregaon (East) (IN)

(21) Appl. No.: 14/321,114

(22) Filed: Jul. 1, 2014

(51) Int. Cl. G06Q 30/02

(52) U.S. Cl. CPC G06Q 30/0204; G06Q 30/0206

(57) ABSTRACT

Systems, apparatus, and computer program products are provided for dynamically accessing performance metrics associated with an identified market or market-segment. In addition, embodiments of the invention provide for presentation of the performance metrics in a readily comprehendible graphical format that facilitates understanding by the user and provides a useful starting point for investment discussion between collaborating entities. The aspects of the invention rely on the most current data in assessing current performance of the market-segment participants, as well, as historical data so that market trend analysis can easily presented to the user.

### FIELD

In general, embodiments of the invention relate to providing information to corporate and investment banking customers and, more particularly, identifying the market-segment associated with a customer and providing dynamic access to performance metrics associated with peer market-segment participants.

### BACKGROUND

In a financial institution setting, senior bankers or the like meet with corporate clients on an ongoing basis with investment ideas, commonly referred to as a “pitch”. These investment idea may include, but are not limited to, merger and acquisition opportunities, capital raising (e.g., Initial Public Offerings (IPOs), follow-on equity, convertible offerings or the like), company restructuring (e.g., spin-offs, consolidation and the like). In order for the banker to persuade the client that the investment ideas bring the necessary value to the client and/or client's shareholders, the investment ideas must be carefully justified with sound quantitative analysis. Such analysis requires the ability of the banker to show the client a deep understanding of industry/market and/or sub-sector/market-segment that the client is part of

Competitive positioning of the client in relation to the client's competitors in a market or market-segment is a key input in understanding, on an ongoing basis, which competitors are performing at a high level and which competitors are lagging in performance. As such, a critical element in understanding the market or market-segment lies in a comparative study of the key companies/competitors that make up the market or market-segment. In this regard, the comparative study requires that key performance metrics, which drive the performance of the market or market-segment, be assessed and presented to the client.

Therefore, a need exists to develop systems, apparatus, methods, computer program products and the like that provide for dynamically assessing and accessing selected performance metrics for a market or market-segment and generating a comparison presentation of the performance metrics associated with the key companies/competitors that make up the market and/or market-segment. The desired invention should incorporate the most current data to insure relevancy of the performance metrics. In addition desired embodiments of the invention should incorporate not only the latest performance metrics but also historical performance metrics so that the client and banking associate can gain an understanding of the latest performance metric trends and analyze how performance has changed over a period of time. Moreover, the desired invention should provide the client and banking associate with dynamic access to a wide variety of different performance metric, beyond those performance metrics currently readily available to the banking associate/client. Equally important, desired embodiments should provide a presentation of more than a listing of statistics but rather should provide a presentation that allows the client and banking associate to compare the performance across an entire market or market-segment. As such, desired embodiments of the invention should aid in generating revenue for the financial institution through additional client investments and provide the client with a positive customer experience through on-demand access to analytical data surrounding comparative performance of market-segment participants.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, methods computer program products or the like for dynamically accessing performance metrics associated with an identified market or market-segment. In addition, embodiments of the invention provide for presentation of the performance metrics in a readily comprehendible graphical format that facilitates understanding by the user and provides a useful starting point for investment discussion between the collaborating parties (e.g., client and the banking associate). The graphical format facilitates the users to perform benchmarking analysis (i.e., determine where the client performs in comparison to their market peers). Further, the invention relies on the most current data in assessing current performance of the market-segment participants, as well, historical data so that market trend analysis can easily be presented to the client.

An apparatus for providing comparable market-segment participant valuation defines first embodiments of the invention. The apparatus includes a computing platform having a memory and at least one processor in communication with the memory. Further, the apparatus includes a comparable market-segment valuation module, which is stored in the memory and executable by the processor. The module is configured to (1) provide display of one or more market-segments associated with a market of interest, (2) receive a first user-input that selects one of the market-segments, (3) in response to receiving the first user-input, provide display of a plurality of performance metrics associated with the market-segment, (4) receive a second user-input that selects one of the performance metrics, (5) determine for a plurality of market-segment participants, current results associated with the selected performance metric; and (6) in response to receiving the second user-input, generate and provide display of a graphical representation that compares the current results of the selected performance metric for each of the plurality of market-segment participants.

In alternate embodiments of the apparatus, the module is further configured to provide display of the plurality of performance metrics associated with the market-segment, wherein the performance metrics include one or more of (1) cash on cash return-on-investment (ROI), (2) return-on-assets (ROA), (3) return-on-equity (ROE), and (4) return-on-invested capital (ROIC). While in other related embodiments of the apparatus, the performance metrics include one or more of (1) market-segment participant growth, (2) average unit volume, and (3) average unit sales.

In still further embodiments of the apparatus, the performance metrics include one or more of (1) average sale amount, (2) average unit size, (3) sales per unit size, (4) fully loaded investment cost, (5) cash investment cost and (6) sales to investment ratio.

In further specific embodiments of the apparatus, the module is further configured to determine, for the plurality of market-segment participants, the current results associated with the selected performance metric based on receiving a data feed from a public information source, such as a source that includes market-segment participant government filing data. In specific embodiments of the apparatus, the data feed may include, but is not limited to, a plurality of (1) average sale, (2) average unit volume, (3) average unit size, (4) sales per size unit, (5) fully loaded investment cost, (6) cash investment cost, and (7) cash on cash return-on-investment (ROI).

Moreover, in further embodiments of the apparatus, the module is further configured to format the graphical representation to automatically adjust based on a unit associated with a corresponding performance metric.

In additional embodiments of the apparatus, the module is further configured to provide the display of the graphical representation that compares the current results of the selected performance metric for each of the plurality of market-segment participants, such that the market-segment participants are displayed in ascending or descending order based on their respective current results for the selected performance metric.

In still further specific embodiments of the apparatus, the module is configured to provide the display of the graphical representation that further includes user-selectable interfaces configured for a user to select at least one of an updated market-segment or an updated performance metric, such that selection of the updated market-segment or updated performance provides for display of a different graphical representation that compares the current results of at least one of the updated performance metric or the plurality of market-segment participants in the updated market-segment.

A method for providing comparable market-segment participant valuation defines second embodiments of the invention. The method includes providing display of one or more market-segments associated with a market of interest, receiving a first user-input that selects one of the market-segments and, in response to receiving the first user-input, providing display of a plurality of performance metrics associated with the market-segment. The method further includes receiving a second user-input that selects one of the performance metrics. determining for a plurality of market-segment participants, current results associated with the selected performance metric, and, in response to receiving the second user-input, generating and providing display of a graphical representation that compares the current results of the selected performance metric for each of the plurality of market-segment participants.

In accordance with specific embodiments of the method, the performance metrics include one or more of (1) cash on cash return-on-investment (ROI), (2) return-on-assets (ROA), (3) return-on-equity (ROE), and (4) return-on-invested capital (ROIC). While in other embodiments of the method, the performance metrics include one or more of (1) market-segment participant growth, (2) average unit volume, and (3) average unit sales. Moreover, in further embodiments of the method, the performance metrics include one or more of (1) average sale amount, (2) average unit size, (3) sales per unit size, (4) fully loaded investment cost, (5) cash investment cost and (6) sales to investment ratio.

In further specific embodiments of the method, determining the current results further includes, determining, for the plurality of market-segment participants, the current results associated with the selected performance metric based on receiving a data feed from a public information source, such as a data feed that includes market-segment participant government filing data. In such embodiments of the method, the data feed may include a plurality of (1) average sale, (2) average unit volume, (3) average unit size, (4) sales per size unit, (5) fully loaded investment cost, (6) cash investment cost, and (7) cash on cash return-on-investment (ROI).

In other specific embodiments the method includes formatting the graphical representation to automatically adjust based on a unit associated with a corresponding performance metric.

Moreover, in other specific embodiments of the method, providing the display of the graphical representation further includes providing the display of the graphical representation that compares the current results of the selected performance metric for each of the plurality of market-segment participants, such that the market-segment participants are displayed in ascending or descending order based on their respective current results for the selected performance metric.

In additional specific embodiments of the method, providing the display of the graphical representation further includes providing, the display of the graphical representation that further includes user-selectable interfaces configured for a user to select at least one of an updated market-segment or an updated performance metric, such that selection of the updated market-segment or updated performance provides for display of a different graphical representation that compares the current results of at least one of the updated performance metric or the plurality of market-segment participants in the updated market-segment.

A computer program product including a non-transitory computer-readable medium defines third embodiments of the invention. The computer-readable medium includes a first set of codes for causing a computer to provide display of one or more market-segments associated with a market of interest, a second set of codes for causing a computer to receive a first user-input that selects one of the market-segments, and a third set of codes for causing a computer to, in response to receiving the first user-input, provide display of a plurality of performance metrics associated with the market-segment. In addition, the computer-readable medium includes a fourth set of codes for causing a computer to receive a second user-input that selects one of the performance metrics, a fifth set of codes for causing a computer to determine, for a plurality of market-segment participants, current results associated with the selected performance metric, and a sixth set of codes for causing a computer to, in response to receiving the second user-input, provide display of a graphical representation that compares the current results of the selected performance metric for each of the plurality of market-segment participants.

Thus, systems, apparatus, methods, and computer program products herein described in detail below provide for a model that pulls together all of the important performance metrics needed to compare peers within a market or market-segment and crates dynamic metric-specific graphical representations that allow the users to analyze peer performance and facilitate benchmarking analysis.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured to provide comparable market-segment participant valuation, in accordance with embodiments of the present invention;

FIG. 2 provides a block diagram of various different performance metrics which may be selected for graphical representation, in accordance with embodiments of the present invention;

FIG. 3 provides a schematic diagram of a system for providing comparable market-segment participant valuation, in accordance with present embodiments of the invention;

FIG. 4 provides a flow diagram of a method for comparable market-segment participant valuation, in accordance with embodiments of the present invention;

FIG. 5 provides a depiction of a user-interface/display for selecting a market-segment, in accordance with embodiments of the present invention;

FIG. 6 provides a depiction of a user-interface/display for selecting a performance metric for an identified market-segment; in accordance with embodiments of the present invention; and

FIG. 7 provides a depiction of a user-interface/display for presenting a graphical representation of a selected performance metric, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for dynamically assessing selected performance metrics for a market or market-segment and generating a graphical presentation of the performance metrics that compares the key companies/competitors that make up the market and/or market-segment. Embodiments of the invention incorporate the most current data to insure relevancy of the performance metrics and historical data so that the user can gain an understanding of the latest performance metric trends and analyze how performance has changed over a period of time. As such, present embodiments of the invention, provide the user with dynamic access to a wide variety of different performance metric, beyond those performance metrics currently readily available to the user. The dynamic generation and presentation of a graphical representation of the selected performance metric provides for more than just a listing of statistics but rather allows the client and banking associate to compare the performance across an entire market or market-segment. As a result, embodiments of the present invention serve to aid in generating revenue for the financial institution through additional client investments and provide the client with a positive customer experience through on-demand access to analytical data surrounding comparative performance of market-segment participants.

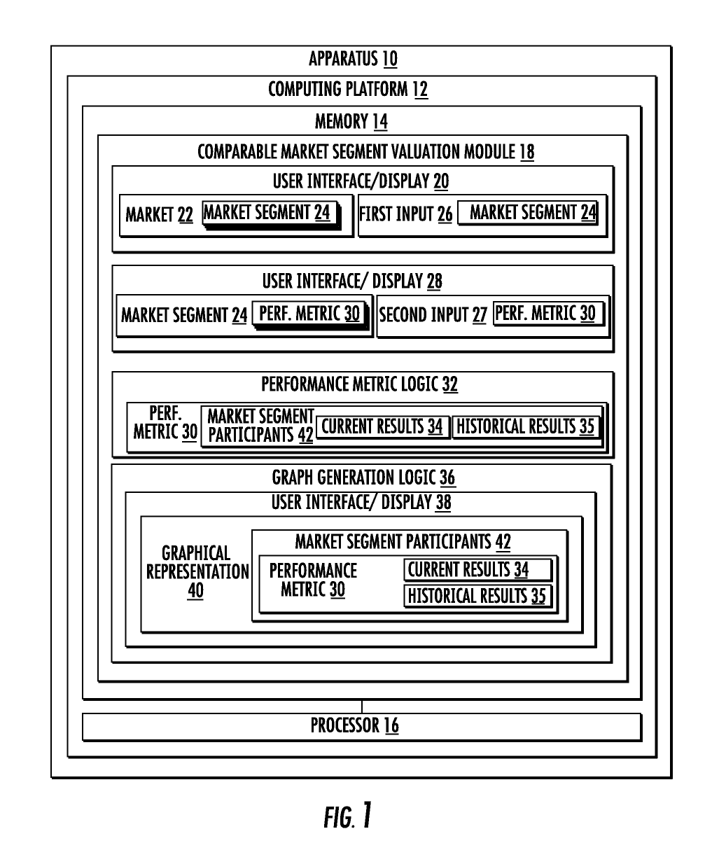

Referring to FIG. 1, block diagram is presented of an apparatus 10 configured for comparable market-segment participant valuation, in accordance with embodiments of the present invention. The apparatus 10 which may include more than one physical device or unit is operable to receive and execute modules, routines and applications, such as comparable market-segment valuation module 18 and the like.

The apparatus 10 includes a computing platform 12 that can receive and execute routines and applications. The computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, the computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 1) that interfaces with any resident programs, such as comparable market-segment valuation module 18 and the like, stored in the memory 14 of apparatus 10. Processor 16 includes various processing subsystems (not shown in FIG. 1) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of comparable market-segment valuation module 18 obviating the need for such applications and modules to be stored in the memory 14.

The memory 14 of apparatus 10 stores comparable market-segment valuation module 18 that is configured to provide comparable market-segment participant (i.e., peer) performance metric assessment and present the results of such a comparison in a graphical representation, in accordance with an embodiments of the present invention. As such, the module 18 is configured to present a user-interface/display 20 of market-segments 24 within a defined market 22 or industry. As such, market-segments 24 may also be commonly referred to as an industry sector or a sub-sector. The display 20 is configured to receive a first user-input 26 that selects a market-segment 24 from amongst one or more market-segments 24 existed within the market 22.

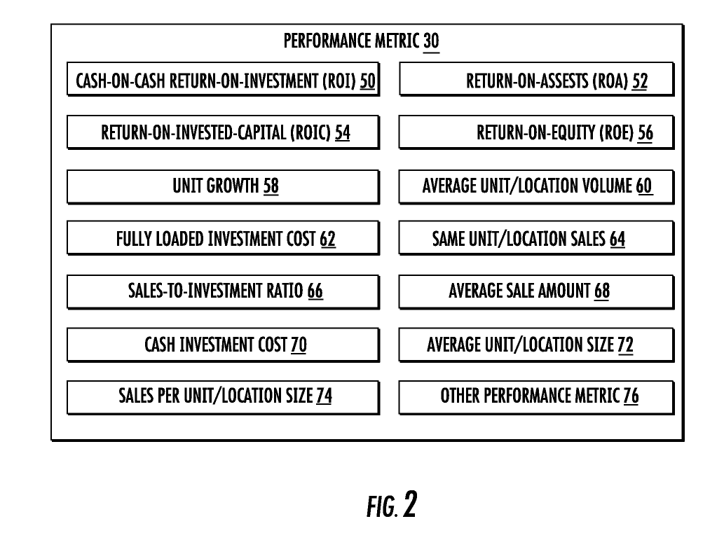

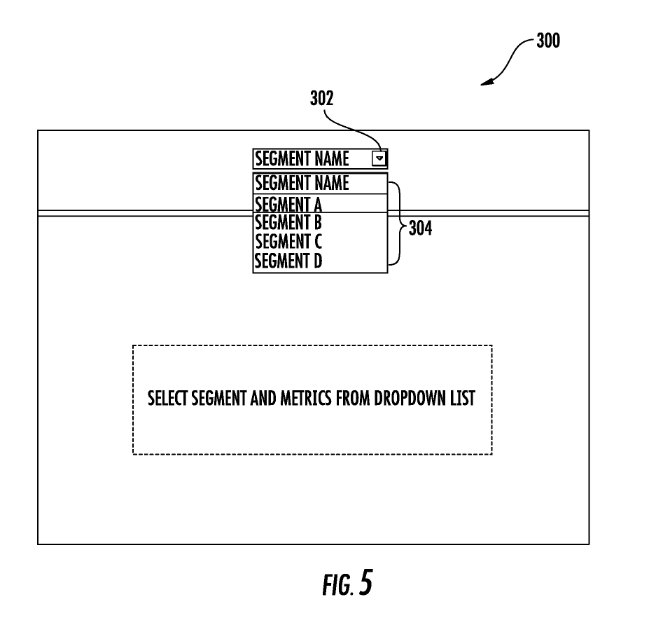

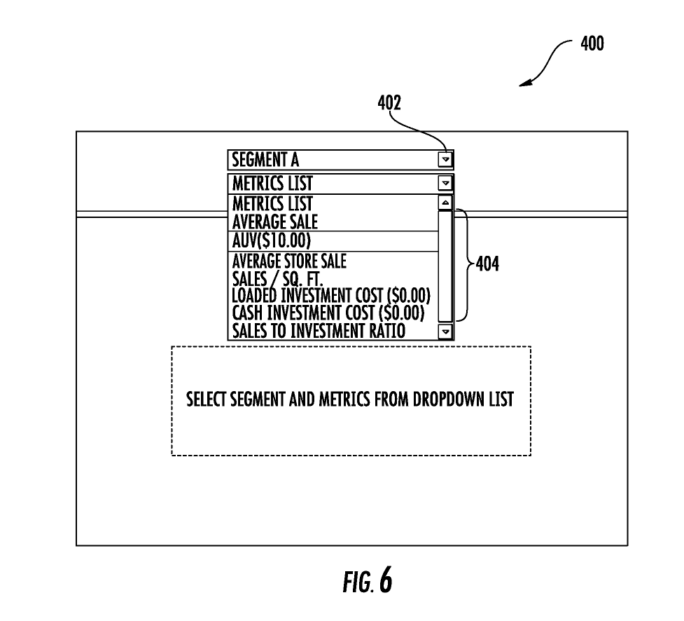

In response to receiving the first user-input 26, the comparable market-segment valuation module 18 is further configured to provide a user-interface display 28 of a plurality of performance metrics 30 associated with the selected market-segment 24. It should be noted that the performance metrics 30 may be presented within the same display/user-interface as the market-segments 24 (i.e., user-interfaces/displays 20 and 24 may be one in the same) or, as shown and described in relation to FIGS. 5 and 6, the selection of the market-segment 24 may prompt display of an additional user-interface/display 28. Further, the user-interface/display 28 is configured to receive a second user-input 27 that selects a performance metric 30 from amongst a plurality of performance metric 30 options. It should be noted that the performance metrics 30 will vary depending on the market/industry and, in some embodiments, depending on the market-segment/industry-sector. As described infra., FIG. 2 highlights various exemplary performance metrics 30 that may be displayed and selected by a user.

Further, comparable market-segment valuation module 18 includes performance metric logic 32 that is configured to determine, for a plurality of market-segment participants 42, current results 34 associated with the selected performance metric 30. The current results may be determined based on accessing a database (not shown in FIG. 1) that stores the most recent performance metric data for the key participants/peers 42 within the segment 22. In specific embodiments of the invention, the performance metric data may be received or otherwise derived from a data feed received from a public information data source, such as a business journal source or the like, that has access to government filing data made by or behalf of the market-segment participant 42. In specific embodiments the data feed may be received or requested to be received on a regularly scheduled basis, such as weekly, monthly, annually or the like. While in other embodiments of the invention in which the performance metrics reflect dynamic, up-to-the-minute results, the selection of the performance metric 30 may prompt the module 18 to receive or otherwise pull the current results 34 from the public information data source.

In addition to the current results 34, the performance metric logic 32 may access a historical database (not shown in FIG. 1) to retrieve historical result 35 of the performance metric 30. The historical database is a data repository that is built-up over time based on continually, over time, receiving data feeds from the public information data sources. In such embodiments of the invention, the current results 34 of the performance metric 30 along with the historical results 35 for the performance metric 30 may be used to subsequently generate a graphical representation 40 that shows performance metric trends for the market-segment participants 42.

The comparable market-segment generation logic 36 additionally includes graph generation logic 36 that is configured to generate a graphical representation 40 of the current results 34 and/or current results 34 and historical results 35 (i.e., trend analysis) and provide a user-interface/display 38 of the graphical representation 40 that compares the current results 34 and or the current results 34 and historical results 35 of the selected performance metric 30 for each of the plurality of market-segment participants 42.

In accordance with embodiments of the present invention, the comparable market-segment valuation module 18 may be accessible to a user from any computing device, such as a personal computer, a laptop computer, a tablet device, a mobile computing device/smart telephone or the like. As such embodiments of the present invention allow a user, such as a financial institution associate/banker to interface with a client, such as a corporate client or the like, to analyze their particular market-segment/industry-sector or benchmark their performance in relation to market peers.

FIG. 2 provides a block diagram of exemplary market-segment performance metrics 30 that may be selected and presented in a graphical representation, in accordance with embodiments of the present invention. It should be noted that the performance metrics 30 shown in FIG. 2 are specific to certain types of markets and/or market-segments, such as retails markets or the like, and that other types of markets and/or market-segments will have other performance metrics not shown in FIG. 2 nor specifically described herein. The performance metrics 30 may include cash-on-cash Return-On-Investment (ROI) 50, which is the cash income on the total amount of cash invested, typically calculated as EBITDA (Earnings Before Interest, Taxes, Depreciation and Amortization) divided to total investment cost; Return-On-Assets (ROA) 52, which shows how profitable a company's assets are in generating revenue; Return-On-Invested-Capital (ROIC) 54, which provides an indication of how well a company is utilizing their capital investments to generate returns; and Return-On-Equity (ROE) 56, which measures a company's profitability in terms of how much profit is generated with the money shareholders have invested.

The performance metrics 30 may also include unit (e.g., retail store, restaurant or the like) growth 58, which represents the percentage of growth of units over a period of time (e.g., annual) and provides an indication as the peer companies expansion activity; average unit volume 60, which provides an average revenue generated by unit of the company; fully loaded investment cost 62, which is the sum of the aggregate purchase price of the investment, the aggregate unreimbursed acquisition expenses of the investment and the aggregate amount of expenses allocated to such Investment; and the same unit sales 64, which represents a percentage of sales growth of units that remained open in the prior time period (e.g., last 12 months).

Moreover, the performance metrics 30 may include sales-to-investment ratio 66, which is the ratio between net sales and net cash invested; average sales amount 68, which is the average purchase amount of a transaction with the company; cash investment cost 70, which is the total amount of cash invested; average unit size 72, which the average physical size of a company's unit; and sales per unit size 74, which the amount of sales per unit size (e.g., per square foot or the like).

Additionally, the performance metrics 30 may include any other performance metric 76 tailored to the market or market-segment. For example, for the restaurant market the performance metrics may include, the Knapp track same store sales, which is based on traffic percentage and price/mix percentage, additionally, the other performance metrics 76 may include 4-wall EBITDA margin, which is the per unit EBITDA.

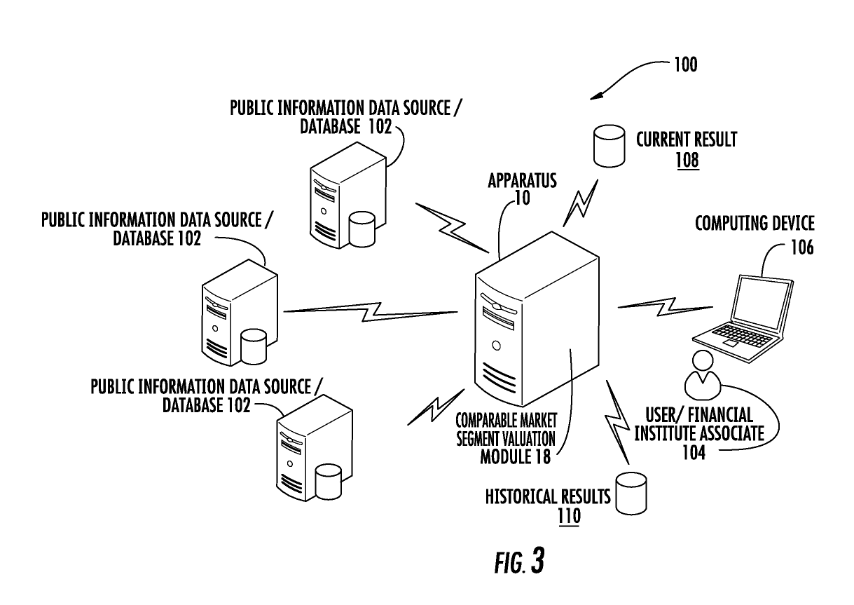

Referring to FIG. 3 a schematic diagram is presented of a system 100 for comparable market-segment participant valuation, in accordance with embodiments of the present invention. The system includes apparatus 10, which includes the requisite computing platform for executing comparable market-segment valuation module 18. The apparatus 10 is includes or is in communication with (wired or wireless) with current results database 108 and historical results database 110. While FIG. 3 depicts the databases 108 and 110 as separate entity it should be apparent that the databases 108 and 110 may exist in a single datastore unit.

In addition, apparatus 10 is in communication (wired or wireless) with one or more public information data sources/databases 102, such as news agency database or the like that compiles publically available information on companies from government required company filing data. The comparable market-segment valuation module 18 may request data feeds from the public information data sources/databases 102 on a regularly scheduled basis (e.g., weekly, monthly, annually or the like) or on an on-demand basis. The data feed itself may include one or more of the performance metrics or the performance metrics may be derived from the information included in the data feed. The current results database 108 houses the most recent data feed received from the public information data source 102 and/or the current performance metrics, once a new/updated data feed is received, the current results database 108 communicates the prior results to the historical database 110 for archiving purposes and for use in determining historical performance metric data (i.e., trend analysis).

The system 100 additionally includes a user 104, such as banking associate or the like that implements a computing device 106 (, PC, laptop, tablet, mobile device or the like) for the purpose of displaying information and providing request inputs to the displays/user-interfaces outputted by the comparable market-segment valuation module 18. It should be apparent that while the illustrated embodiment of FIG. 3 shows the comparable market-segment valuation module 18 as being a server-based application accessed by the Internet or an intranet, in other embodiments the comparable market-segment valuation module 18 may be stored and executed directly on the computing device 106. In specific embodiments of the invention, a user's request for graphical representation of a selected performance metric will result in the comparable segment valuation module 18 accessing the current results database 108 and/or the historical results database 110 based on the selected performance metric. In alternate embodiments in which the performance metric reflects real-time (i.e., up-to-the minute) or the most current results (e.g., within prior hour, prior day, prior week, prior month) performance, the user's request for graphical representation of a selected performance metric may trigger a request for a data feed (i.e., data fetch) from one or more of the public information data sources 102 to insure that the performance metric reflects the most current performance data available.

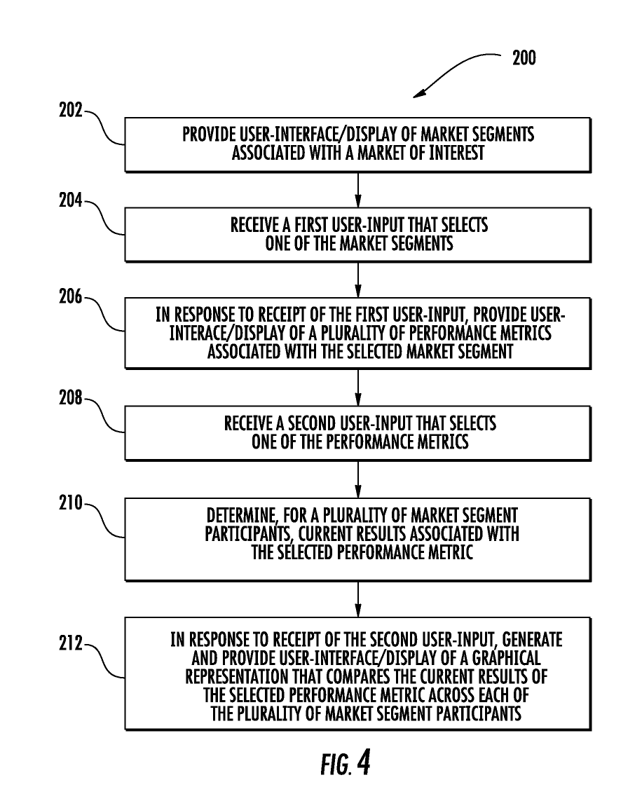

FIG. 4 is a flow diagram of a method 200 for comparable market-segment participant valuation, in accordance with embodiments of the present invention. At Event 202, a user interface/display of market segments associated with a market of interest is presented to a user. Such a display/user interface is shown and described in relation to FIG. 5, infra. It should be noted that in the event that a given market does not have defined market-segments, Event 202 would be unwarranted and, as such deemed as optional. At Event 204, a first user-input is received that selects one of the market-segments. In response to receiving the first user-input that selects the market-segment, at Event 206, a user-interface/display is provided of a plurality of performance metrics associated with the selected market-segment. In optional embodiments further attributes associated with the market-segment participants and/or performance metric may be displayed, such as geographic area of the market-segment participants, type of market-segments participants (e.g., franchised vs. company-owned) to be used in determining the performance metric and the like. Such a display/user interface is shown and described in relation to FIG. 6, infra.

At Event 208, a second user-input is received that selects one of the performance metrics. In those embodiments, in which further attributes are displayed/selectable, the second user-input may include selection of one or more of the further attributes associated with the market-segment participants and/or performance metric. At Event 210, current results for the selected performance metric are determined or retrieved for a plurality of market-segment participants. In addition, if the selected performance metric entails historical results, the historical results are retrieved from a corresponding historical results repository. In specific embodiments, determination of the current results may include fetching data from a public information source or the like in response to the selection of the performance metric, to insure that the current results reflect the most up-to-the-minute performance metric data available.

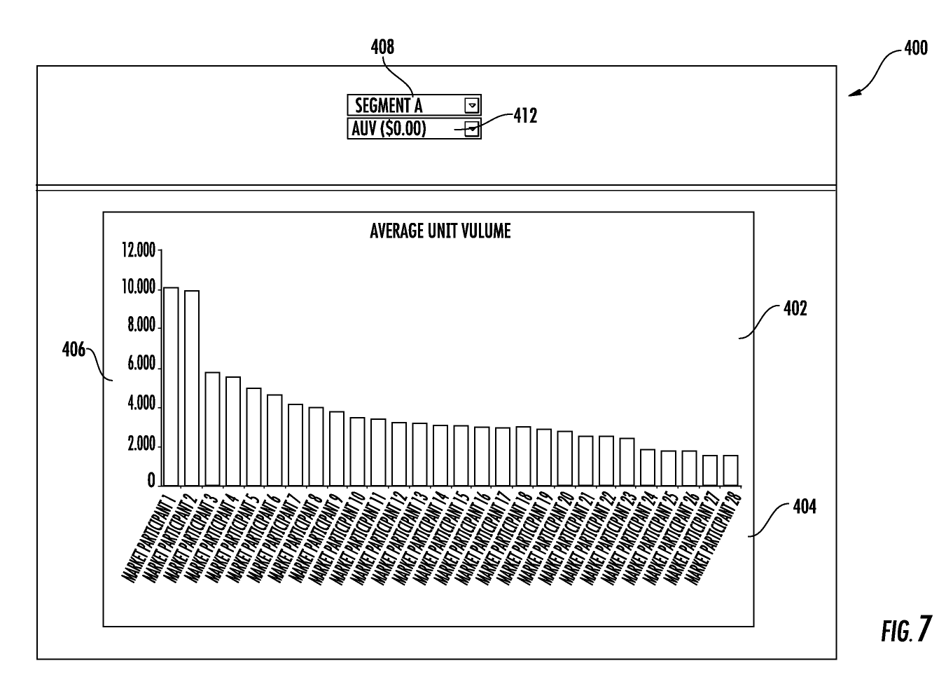

In response to receiving the second user-input and determining the current results, at Event 212, a user-interface display is generated and provided of a graphical representation that compares the current results, and/or, in some embodiments, the historical results, of the selected performance metric across each of the plurality of market-segment participants. It should be noted that such generation of the graphical representation may include necessary formatting to take into the unit of measure associated with the performance metric and the scaling required of the graphical representation on the user-interface/display. Such a display/user interface is shown and described in relation to FIG. 7, infra.

Referring to FIG. 5, a user-interface/display 300 is presented that allows a user, such as a financial institution associate/banker or the like, to select a market segment, in accordance with embodiments of the present invention. It should be noted that the module itself may be market-specific or a preceding user-interface display may have been employed for selection of a market. In the illustrated embodiment of FIG. 5, a drop-down menu 302 is implemented to display a listing 304 of the market-segments within a defined market. Other embodiments of the invention may display the market-segments in a different selectable format. The user selects one of the market-segments listed in the drop-down menu and, as a result, the user-interface/display shown in FIG. 6 is presented to the user.

Referring to FIG. 6, a user-interface/display 400 is presented that allows the user to select a performance metric from amongst a plurality of performance metrics associated with the selected market-segment. In this regard, the performance metrics are market-segment-specific or, at least, market-specific. In the illustrated embodiment of FIG. 6, a drop-down menu 402 is implemented to display a listing 404 of the market-segments within a defined market. Other embodiments of the invention may display the market-segments in a different selectable format. In additional embodiments of the invention (not shown in FIG. 6), other attributes/criteria associated with the market-segment participants (e.g., location, type, or the like) and/or the performance metric (e.g., date-range or the like) may be displayed and selected by the user. Such selection of other attributes serves to further limit the market-segment participants included in the resulting graphical representation and/or further define the performance metric. The user selects one of the performance metrics listed in the drop-down menu and, as a result, current results and/or historical results associated with the selected performance metric are determined and the user-interface/display shown in FIG. 7 is presented to the user.

Referring to FIG. 7, a user-interface/display 400 is shown that depicts the graphical representation 402 that compares the current results, and/or, in some embodiments, the historical results, of the selected performance metric across each of the plurality of market-segment participants, in accordance with embodiments of the present invention. In the illustrated embodiment shown, the graphical representation is a bar graph listing highlighting the current results for the performance metric, Average Unit Volume (AUV). The market-level participants 404 are shown along the x-axis and the units 406 of the performance metric are shown along the y-axis. It should be noted that in the illustrated example of FIG. 7, the performance metric participants are listed in the bar graph in left-to-right descending order (i.e., the market-segment participant with the highest “average unit volume” is shown furthest to the left in the bar graph). Additionally, the module may configure display within the graph in an ascending order or any other order (e.g., alphabetical based on name of market-segment participant) or the user may be able to configure the graphical representation to display the market-segment participant in a desired order. In such embodiments of the invention, user-interface/display 400 may include a drop-down menu (not shown in FIG. 7) or the like that allows the user to select in desired order for displaying the market-segment participants within the graphical representation.

Additionally, user-interface/display 400 provides for drop-down menus 408 and 410 for listing the other market-segments (drop-down menu 408) and related performance metrics (drop-down menu 410), such that a user may select one of the other market segments and a corresponding performance metric 410 or select a different performance metric for the currently selected market-segment and, in response to selection of another market-segment and/or performance metric, the graphical representation may be updated/changed to reflect the selected market-segment and/or performance metric.

Thus, systems, apparatus, methods, and computer program products described above provide for a model that pulls together all of the important performance metrics needed to compare peers within a market or market-segment and creates dynamic metric-specific graphical representations that allow the users to analyze peer performance and facilitate benchmarking analysis.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for providing comparable market-segment participant valuation, the system comprising:
a computing platform having a memory and at least one processor in communication with the memory;
a comparable market-segment valuation module stored in the memory, executable by the processor and configured to (1) provide display of one or more market-segments associated with a market of interest, (2) receive a first user-input that selects one of the market-segments, (3) in response to receiving the first user-input, provide display of a plurality of performance metrics associated with the market-segment, (4) receive a second user-input that selects one of the performance metrics, (5) determine for a plurality of market-segment participants, current results associated with the selected performance metric; and (6) in response to receiving the second user-input, generate and provide display of a graphical representation that compares the current results of the selected performance metric for each of the plurality of market-segment participants.

2. The apparatus of claim 1, wherein the comparable market-segment valuation module is further configured to provide display of the plurality of performance metrics associated with the market-segment, wherein the performance metrics include one or more of (1) cash on cash return-on-investment (ROI), (2) return-on-assets (ROA), (3) return-on-equity (ROE), and (4) return-on-invested capital (ROIC).

3. The apparatus of claim 1, wherein the comparable market-segment valuation module is further configured to provide display of the plurality of performance metrics associated with the market-segment, wherein the performance metrics include one or more of (1) market-segment participant growth, (2) average unit volume, and (3) average unit sales.

4. The apparatus of claim 1, wherein the comparable market-segment valuation module is further configured to provide display of the plurality of performance metrics associated with the market-segment, wherein the performance metrics include one or more of (1) average sale amount, (2) average unit size, (3) sales per unit size, (4) fully loaded investment cost, (5) cash investment cost and (6) sales to investment ratio.

5. The apparatus of claim 1, wherein the comparable market-segment valuation module is further configured to determine, for the plurality of market-segment participants, the current results associated with the selected performance metric based on receiving a data feed from a public information source that includes market-segment participant government filing data.

6. The apparatus of claim 1, wherein the comparable market-segment valuation module is further configured to determine, for the plurality of market-segment participants, the current results associated with the selected performance metric based on receiving a data feed from a public information source that includes a plurality of (1) average sale, (2) average unit volume, (3) average unit size, (4) sales per size unit, (5) fully loaded investment cost, (6) cash investment cost, and (7) cash on cash return-on-investment (ROI).

7. The apparatus of claim 1, the comparable market-segment valuation module is further configured to format the graphical representation to automatically adjust based on a unit associated with a corresponding performance metric.

8. The apparatus of claim 1, wherein the comparable market-segment valuation module is further configured to provide the display of the graphical representation that compares the current results of the selected performance metric for each of the plurality of market-segment participants, wherein the market-segment participants are displayed in ascending or descending order based on their respective current results for the selected performance metric.

9. The apparatus of claim 1, wherein the comparable market-segment valuation module is further configured to provide the display of the graphical representation that further includes user-selectable interfaces configured for a user to select at least one of an updated market-segment or an updated performance metric, wherein selection of the updated market-segment or updated performance provides for display of a different graphical representation that compares the current results of at least one of the updated performance metric or the plurality of market-segment participants in the updated market-segment.

10. A method for providing comparable market-segment participant valuation, the method comprising:
providing, by a computing device processor, display of one or more market-segments associated with a market of interest;
receiving, by a computing device processor, a first user-input that selects one of the market-segments;
in response to receiving the first user-input, providing, by a computing device processor, display of a plurality of performance metrics associated with the market-segment;
receiving, by a computing device processor, a second user-input that selects one of the performance metrics;
determining, by a computing device processor, for a plurality of market-segment participants, current results associated with the selected performance metric; and
in response to receiving the second user-input, generating and providing, by a computing device processor, display of a graphical representation that compares the current results of the selected performance metric for each of the plurality of market-segment participants.

11. The method of claim 10, wherein providing display of the plurality of performance metrics further includes providing, by the computing device processor, display of the plurality of performance metrics associated with the market-segment, wherein the performance metrics include one or more of (1) cash on cash return-on-investment (ROI), (2) return-on-assets (ROA), (3) return-on-equity (ROE), and (4) return-on-invested capital (ROIC).

12. The method of claim 10, wherein providing display of the plurality of performance metrics further includes providing, by the computing device processor, display of the plurality of performance metrics associated with the market-segment, wherein the performance metrics include one or more of (1) market-segment participant growth, (2) average unit volume, and (3) average unit sales.

13. The method of claim 10, wherein providing display of the plurality of performance metrics further includes providing, by the computing device processor, display of the plurality of performance metrics associated with the market-segment, wherein the performance metrics include one or more of (1) average sale amount, (2) average unit size, (3) sales per unit size, (4) fully loaded investment cost, (5) cash investment cost and (6) sales to investment ratio.

14. The method of claim 10, wherein determining the current results further comprises, determining, by the computing device processor, for the plurality of market-segment participants, the current results associated with the selected performance metric based on receiving a data feed from a public information source that includes market-segment participant government filing data.

15. The method of claim 10, wherein determining the current results further comprises, determining, by the computing device processor, for the plurality of market-segment participants, the current results associated with the selected performance metric based on receiving a data feed from a public information source that includes a plurality of (1) average sale, (2) average unit volume, (3) average unit size, (4) sales per size unit, (5) fully loaded investment cost, (6) cash investment cost, and (7) cash on cash return-on-investment (ROI).

16. The method of claim 10, further comprising formatting, by a computing device processor, the graphical representation to automatically adjust based on a unit associated with a corresponding performance metric.

17. The method of claim 10, wherein providing the display of the graphical representation further comprises providing, by the computing device processor, the display of the graphical representation that compares the current results of the selected performance metric for each of the plurality of market-segment participants, wherein the market-segment participants are displayed in ascending or descending order based on their respective current results for the selected performance metric.

18. The method of claim 10, wherein providing the display of the graphical representation further comprises providing, by the computing device processor, the display of the graphical representation that further includes user-selectable interfaces configured for a user to select at least one of an updated market-segment or an updated performance metric, wherein selection of the updated market-segment or updated performance provides for display of a different graphical representation that compares the current results of at least one of the updated performance metric or the plurality of market-segment participants in the updated market-segment.

19. A computer program product comprising:
a non-transitory computer-readable medium comprising:
a first set of codes for causing a computer to provide display of one or more market-segments associated with a market of interest;
a second set of codes for causing a computer to receive a first user-input that selects one of the market-segments;
a third set of codes for causing a computer to, in response to receiving the first user-input, provide display of a plurality of performance metrics associated with the market-segment;
a fourth set of codes for causing a computer to receive a second user-input that selects one of the performance metrics;
a fifth set of codes for causing a computer to determine, for a plurality of market-segment participants, current results associated with the selected performance metric; and
a sixth set of codes for causing a computer to, in response to receiving the second user-input, provide display of a graphical representation that compares the current results of the selected performance metric for each of the plurality of market-segment participants.

20. The computer program product of claim 19, wherein the fourth set of codes is further configured to cause the computer to provide display of the plurality of performance metrics associated with the market-segment, wherein the performance metrics include two or more of (1) cash on cash return-on-investment (ROI), (2) return-on-assets (ROA), (3) return-on-equity (ROE), (4) return-on-invested capital (ROIC), (5) market-segment participant growth, (6) average unit volume, (7) average unit sales, (8) average sale amount, (9) average unit size, (10) sales per unit size, (11) fully loaded investment cost, (12) cash investment cost and (13) sales to investment ratio.
